(19) United States
(12) Patent Application Publication
(10) Pub. No.: US 2016/0180204 A1
(43) Pub. Date: Jun. 23, 2016

(54) IMAGE FORMING APPARATUS AND JAM DETECTION METHOD

(71) Applicant: CASIO COMPUTER CO., LTD., Tokyo (JP)

(72) Inventor: Yukinobu IMOTO, Hidaka-shi (JP)

(73) Assignee: CASIO COMPUTER CO., LTD., Tokyo (JP)

(21) Appl. No.: 14/942,767

(22) Filed: Nov. 16, 2015

(30) Foreign Application Priority Data
Dec. 18, 2014 (JP) 2014-255833

(51) Int. Cl. G06K 15/00; G06K 15/02; G06K 15/16; G06K 15/12

(52) U.S. Cl. CPC G06K 15/4085; G06K 15/12; G06K 15/024; G06K 15/16

(57) ABSTRACT

An object is to reduce the complexity of an operation and precisely detects a jam occurrence. A mark sensor detects an end portion of a label pasted on a print target medium that is long paper and being conveyed. A control section acquires, based on a difference between a time point at which an end portion of a first label has been detected by the mark sensor and a time point at which an end portion of the next label has been detected by the mark sensor, an interval between the labels, and takes this interval as a reference point. Then, the control section judges whether an interval between labels detected by the mark sensor is more than the reference interval and, when it is more than the reference interval, judges that the conveyance of the paper has been stopped.

### CROSS-REFERENCE TO RELATED APPLICATION

This application is based upon and claims the benefit of priority from the prior Japanese Patent Application No. 2014-255833, filed Dec. 18, 2014, the entire contents of which are incorporated herein by reference.

### BACKGROUND OF THE INVENTION

1. Field of the Invention

The present invention relates to an image forming apparatus and a jam detection method.

2. Description of the Related Art

Conventionally, there is an electrophotographic image forming apparatus. In this age forming apparatus, generally, the photosensitive drums of a development device are equally electrified and initialized, and latent images are formed on the photosensitive drums by optical writing and developed to toner images. Then, the toner images are directly or indirectly transferred onto a print target medium and fixed by a fixing device.

As the print target medium, continuous-form paper such as rolled long paper (hereinafter referred to as long paper) or a cut sheet (flat paper) acquired by cutting paper into a fixed shape is used. Examples of the long paper include label paper and long paper with marks. The label paper is long paper where labels have been pasted on rolled paper at predetermined intervals and seal paper portions excluding the label portions have been peeled off (die-cut rolled paper). The long paper with marks is long paper where marks for image positioning have been printed in advance on areas other than print target areas at predetermined intervals. As a jam detection method for long paper in an image forming apparatus that performs printing on long paper, there is a method where an image positioning mark printed in advance on long paper or the front end and the rear end of a label pasted on long paper are detected, the detection cycle is compared to a reference value, and a judgment is made that a paper jam has occurred when the detection cycle is more than or less than the reference value. (for example, refer to Japanese Patent Application Laid-open (Kokai) Publication Nos. 07-081801 and 08-025724).

### SUMMARY OF THE INVENTION

In accordance with one aspect of the present invention, there is provided an image forming apparatus comprising; a first detection section which detects marks printed in advance on a print target medium that is being conveyed or labels pasted on the print target medium; a measurement section which measures an interval between marks or an interval between labels detected by the first detection section after conveyance of the print target medium is started, and sets the interval as a reference interval; and a judgment section which judges whether the conveyance of the print target medium has been stopped, based on an interval between marks or an interval between labels detected by the first detection section after measurement by the measurement section and the reference interval.

In accordance with another aspect of the present invention, there is provided a jam detection method comprising; a first detection step of detecting marks printed in advance on a print target medium or labels pasted on the print target medium; a measurement step of measuring an interval between marks or an interval between labels detected after conveyance of the print target medium is started, and setting the interval as a reference interval; and a judgment step of judging whether the conveyance of the print target medium has been stopped, based on an interval between marks or an interval between labels detected after measurement of the interval between the marks or the interval between the labels.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is an overall conceptual diagram showing an image forming apparatus 10 according to an embodiment of the present invention, which performs printing on long paper or a cut sheet;

FIG. 2 is a block diagram showing the structure of a partial control system of the image forming apparatus 10 according to the present embodiment;

FIG. 3 is a perspective view of a print target medium (long paper) 21a in the present embodiment;

FIG. 4 is a flowchart for describing an operation (jam detection processing) of the image forming apparatus 10 according to the present embodiment; and

FIG. 5 is another flowchart for describing the operation (jam detection processing) of the image forming apparatus 10 according to the present embodiment.

### DETAILED DESCRIPTION OF THE PREFERRED EMBODIMENT

An embodiment of the present invention will hereinafter be described with reference to the drawings.

A. Structure of Embodiment

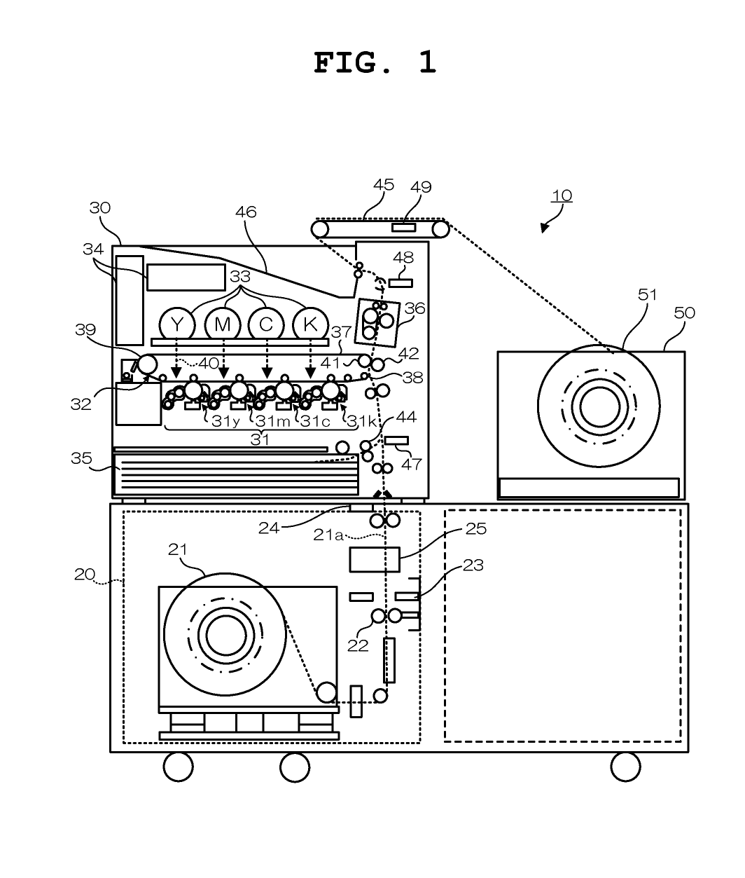

FIG. 1 is an overall conceptual diagram showing an image forming apparatus 10 according to an embodiment of the present invention, which performs printing on long paper or a cut sheet (flat paper). The image forming apparatus 10 in FIG. 1 constituted by a long paper feeding section 20, a printer body 30, and a long paper rolling section 50. The long paper feeding section 20 is installed under the printer body 30, in which a paper feed roll 21 is installed. A print target medium 21a that is long paper pulled from this paper feed roll 21 is supplied to the printer body 30 positioned thereabove.

Paper feed rollers 22 in FIG. 1 fix the positions of end portions of the print target medium 21a before it enters the printer body 30, and a mark sensor 23 detects end portions of labels attached on the print target medium (long paper) 21a when the print target medium 21a is being conveyed. Also, an end sensor 24 in FIG. 1 detects an end portion of the print target medium (long paper) 21a to be supplied to the printer body 30, and an auto cutter 25 cuts the print target medium (long paper) 21a when predetermined printing is completed.

The printer body 30, which is an electrophotographic, intermediate transfer, and tandem type color image forming device, is constituted by a drum/development device 31, transfer belt device 32, toner cartridges 33, electric equipment sections 34, a paper feeding section 35, a fixing device 36, etc.

The toner cartridges 33 are arranged above the transfer belt device 32, and the drum/development device 31 is arranged substantially directly under the transfer belt device 32. The transfer belt device 32 includes an intermediate transfer belt 37, driving rollers 38, and a follower roller 39. The drum/development device 31 is structured such that four development devices 31k, 31c, 31m, and 31y are arranged side-by-side in multiple stages from right to left in the drawing and come in contact with the lower driving surface of the intermediate transfer belt 37 of the transfer belt device 32.

The toner of black (K), cyan (C), magenta (M), and yellow (Y) shown in the drawing as K, C, M, and Y are supplied to these development devices 31k, 31c, 31m, and 31y, respectively, from the four toner cartridges 33.

The four toner cartridges 33 are arranged above the upper running surface of the intermediate transfer belt 37, in which the toner of black (K), cyan (C), magenta (M), and yellow (Y) to be supplied are accommodated, respectively. In areas between the toner cartridges 33 and the drum/development device 31, toner vertical conveyance paths 40 are arranged, respectively, and a fixed amount of toner is conveyed into the drum/development device 31 from each toner cartridge 33.

As described above, the drum/development device 31 is structured such that the four development devices 31k, 31c, 31m, and 31y are arranged side-by-side in multiple stages, and each development device 31k, 31c, 31m, and 31y has the same structure except their toner colors for developing images. Among these development devices 31k, 31c, 31m, and 31y, three development devices 31c, 31m, and 31y on the lower flow side (the left-hand side in the drawing) form color images on the intermediate transfer belt 37 by using the color toner of cyan (C), magenta (M), and yellow (Y) which are the three primary colors of subtractive color mixing. The development device 31k forms a monochrome image on the intermediate transfer belt 37 by using the color toner of black (K) which is mainly used for characters, dark portions of images, etc.

The transfer belt device 32 includes the endless intermediate transfer belt 37 positioned in a substantially center area in the printer body 30 and having a flat loop shape extending in the horizontal direction of the drawing, and the driving rollers 38 and the follower roller 39 around which the intermediate transfer belt 37 is wrapped and circularly moved in the counterclockwise direction in the drawing.

The transfer belt device 32 also includes a secondary transfer backup roller 41 which is positioned above the driving rollers 38 and around which the intermediate transfer belt 37 is wrapped. This secondary transfer backup roller 41 comes in pressure contact with a secondary transfer roller 42 via the intermediate transfer belt 37.

The print target medium 21a, which is conveyed to the printer body 30, comes in pressure contact with the intermediate transfer belt 37 when it is conveyed between the secondary transfer backup roller 41 and the secondary transfer roller 42. As a result, color images formed on the intermediate transfer belt 37 by use of the color toner of cyan (C), magenta (M), and yellow (Y), and a monochrome image formed thereon by use of the toner of black (K) are sequentially transferred onto the print target medium 21a that is long paper, and supplied to the fixing device 36.

Also, the paper feeding section 35 includes a paper cassette having cut sheets placed therein. Note that, in the descriptions below, long paper and cut sheets are collectively referred to as the print target medium 21a. A cut sheet in the paper cassette is conveyed to the secondary transfer backup roller 41 and the secondary transfer roller 42 through conveyance rollers 44, as in the case of long paper. Then, color images formed on the intermediate transfer belt 37 by use of the color toner of cyan (C), magenta (M), and yellow (Y), and a monochrome image formed thereon by use of the toner of black (K) are sequentially transferred onto the cut sheet serving as the print target medium 21a, and supplied to the fixing device 36.

The fixing device 36 is a belt-type heat fixing device and fixes a toner image transferred onto the print target medium 21a that is long paper or a cut sheet. Long paper conveyed from the fixing device 36 is wrapped around a rolling-up roll 51 arranged in the long paper rolling section 50, via a face-up unit 45. On the other hand, a cut sheet conveyed from the fixing device 36 is ejected to a paper output tray 46 arranged on the upper surface of the device. A standby sensor 47 in FIG. 1 detects the print target medium (long paper or cut sheet) 21a to be conveyed to the secondary transfer backup roller 41 and the secondary transfer roller 42 positioned above the standby sensor 47, and a paper ejection sensor 48 detects the print target medium (long paper and cut sheet) 21a to be ejected from the fixing device 36. A face-up unit passing sensor 49 in FIG. 1 detects the print target medium (long paper) 21a that passes through the face-up unit 45.

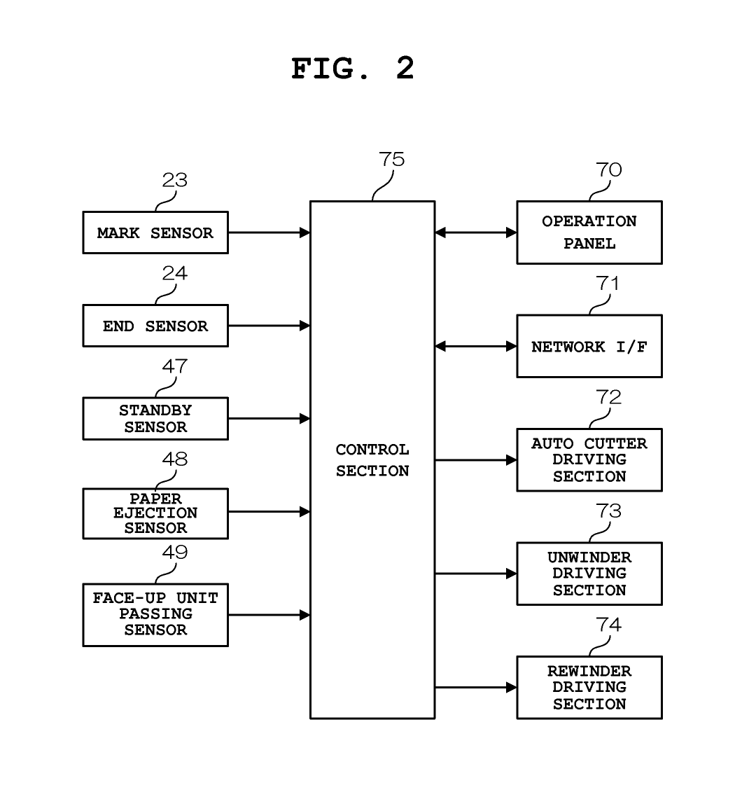

FIG. 2 is a block diagram showing the structure of the partial control system of the image forming apparatus 10 according to the present embodiment. Note that sections corresponding to those in FIG. 1 are provided with the same reference numerals, and explanations thereof are omitted. In FIG. 2, the image forming apparatus 10 includes the mark sensor 23, the end sensor 24, the standby sensor 47, the paper ejection sensor 48, the face-up unit passing sensor 49, an operation panel 70, a network I/F 71, an auto cutter driving section 72, an unwinder driving section 73, a rewinder driving section 74, and a control section 75.

The mark sensor 23, the end sensor 24, the standby sensor 47, the paper ejection sensor 48, and the face-up unit passing sensor 49 detect the edge of light intensity based on the transmissivity of light transmitted to the print target medium (long paper) 21a or change in the reflectivity of the reflected light. The mark sensor 23 detects the head side edge or the rear side edge of each label pasted on the print target medium (long paper) 21a (or marks printed in advance on the print target medium (long paper) 21a) based on the transmissivity of transmitted light or change in the reflectivity of reflected light. The end sensor 24, the standby sensor 47, the paper ejection sensor 48, and the face-up unit passing sensor 49 detect the passage of an end portion of the print target medium (long paper) 21a based on the transmissivity of transmitted light or change in the reflectivity of reflected light.

Note that a threshold value for detection by the transmissivity of transmitted light or the reflectivity of reflected light by the mark sensor 23 is set in advance, and printing on each label pasted on the print target medium (long paper) 21a is performed based on each detection timing.

Also, a structure may be adopted in which marks are printed in advance on the print target medium (long paper) 21a by using a fluorescent ink containing a fluorescent material, and the mark sensor 23 detects the fluorescence by using ultraviolet irradiation. Moreover, a structure may be adopted in which marks are printed in advance on the print target medium (long paper) 21a by using a magnetic ink containing magnetic powder (ferrous oxide, chromium oxide, metal, and the like), and the mark sensor 23 detects magnetism emitted from the magnetic material. In this structure, magnetic patterns may be recorded on areas printed with the magnetic ink by use of magnetic recording means so that plural types of marks can be identified. This makes it possible that plural types of print target media (long paper) 21a are used together and plural types of labels having different sizes are used together for one print target medium (long paper) 21a. As a matter of course, as a method for detection by the mark sensor 23, a method of detecting conductivity/permittivity may be adopted in place of the above-described method. In the method of detecting conductivity, marks are formed using a conductive ink and a resistance measurement sensor that measures the value of resistance is used. In the method of detecting permittivity, marks are formed using an insulation ink and an electrostatic capacity sensor that measures electrostatic capacity is used. These methods may be used in combination. In this case, it goes without saying that printing timing in accordance with mark positions conforming to each measuring method is set in advance.

The operation panel 70 is constituted by, for example, ten keys, function keys, a touch panel, or the like, by which the number of prints, a result of selection between single-side printing and double-side printing, and the like are indicated and inputted, or an operation status (including error display related to the occurrence of a jam or the like), setting details, and the like are displayed.

The network I/F 71 is one of the interfaces for communicating with a host device not shown, and notifies the host device of, for example, a jam occurrence. The auto cutter driving section 72 drives the auto cutter 25 when predetermined printing is completed, and cuts the print target medium (long paper) 21a, in accordance with an instruction from the control section 75. The unwinder driving section 73 drives the paper feed roll 21 and sends the print target medium (long paper) 21a at a predetermined speed, in accordance with an instruction from the control section 75. The rewinder driving section 74 drives the rolling-up roll 51, and rolls up the ejected print target medium (long paper) 21a at a predetermined speed, in accordance with an instruction from the control section 75.

The control section 75 performs the overall control of the above-described sections. In particular, in the present embodiment, the control section 75 measures an interval between a first label and a second label detected by the mark sensor 23 after the conveyance of the print target medium (long paper) 21a is started, sets it as a reference interval, and judges whether the conveyance of the print target medium (long paper) 21a has been stopped based on intervals for a third label and the following labels detected by the mark sensor 23 after the measurement and the reference interval. Also, before an interval between labels detected by the mark sensor 23 is measured, a preliminary portion that does not have labels pasted thereon passes through the conveyance path. Accordingly, by the end sensor 24, the standby sensor 47, the paper ejection sensor 48, and the face-up unit passing sensor 49 arranged along the conveyance path, the control section 75 sequentially judges whether the print target medium (long paper) 21a has passed through each of the sensors within a predetermined time period, and thereby judges whether the conveyance of the print target medium (long paper) 21a has been stopped.

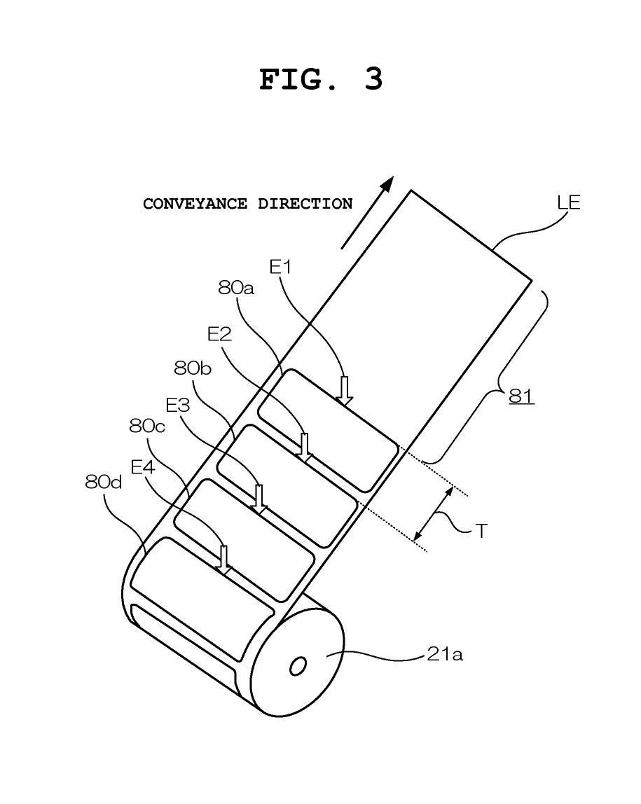

FIG. 3 is a perspective view of the print target medium (long paper) 21a in the present embodiment. In this embodiment, the control section 75 takes, as a reference point, a time point at which an end portion E1 of a first label 80a pasted on the print target medium (long paper) 21a has been detected by the mark sensor 23 (a time point at which the end portion has passed through this sensor), acquires a difference between the reference point and a time point at which an end portion E2 of the next label 80b has been detected by the mark sensor 23 (a time point at which the end portion has passed through this sensor), measures an interval between these labels pasted on the print target medium (long paper) 21a, and takes this interval between the labels 80a and 80b as a reference interval T. Then, when end portions E3, E4, and . . . of the following labels 80c, 80d, and . . . are not detected at the reference intervals T by the mark sensor 23, the control section 75 judges that a jam has occurred and performs processing of displaying a notification regarding the jam occurrence on the operation panel 70.

As described above, in the present embodiment, the end portions E1 and E2 of the first label 80a and the next label 80b pasted in advance on the print target medium (long paper) 21a are detected, whereby the actual label interval is measured. As result of this configuration, the user is not required to know in advance each interval between labels pasted in advance on the print target medium (long paper) 21a or the size of the labels, whereby the complexity of the operation can be reduced.

Also, during a time period from when the end portion E1 of the first label 80a is detected by the mark sensor 23 until when an interval between this label and the next label is measured, the control section 75 cannot make a judgment regarding a jam occurrence based on the reference interval T. Accordingly, until the measurement of the interval between the labels is completed, the control section 75 measures time periods spent by an end portion LE of the print target medium (long paper) 21a to pass through the mark sensor 23, the standby sensor 47, the paper ejection sensor 48, and the face-up unit passing sensor 49, respectively. Then, when the time periods are longer than a set time period or when the print target medium (long paper) 21a has not passed through each sensor within a set time TR, the control section 75 judges that a jam has occurred and performs processing of displaying a notification regarding the jam occurrence on the operation panel 70. The set time TR herein corresponds to time from when the conveyance of the print target medium (long paper) 21a is started (or from when it has passed through the mark sensor 23 or the end sensor 24) until when the print target medium (long paper) 21a reaches a corresponding sensor, and can be acquired based on the conveyance velocity (linear velocity) of the print target medium (long paper) 21a and the distance to the corresponding sensor.

As described above, in the present embodiment, until the measurement of an interval between labels is completed, a jam is judged to have occurred when an end portion of the print target medium (long paper) 21a does not pass through the mark sensor 23, the standby sensor 47, the paper ejection sensor 48, and the face-up unit passing sensor 49 arranged along the conveyance path of the print target medium (long paper) 21a within the set time TR. As a result of this configuration, erroneous detection of a jam of a preliminary portion 81 that does not have labels pasted thereon can be prevented.

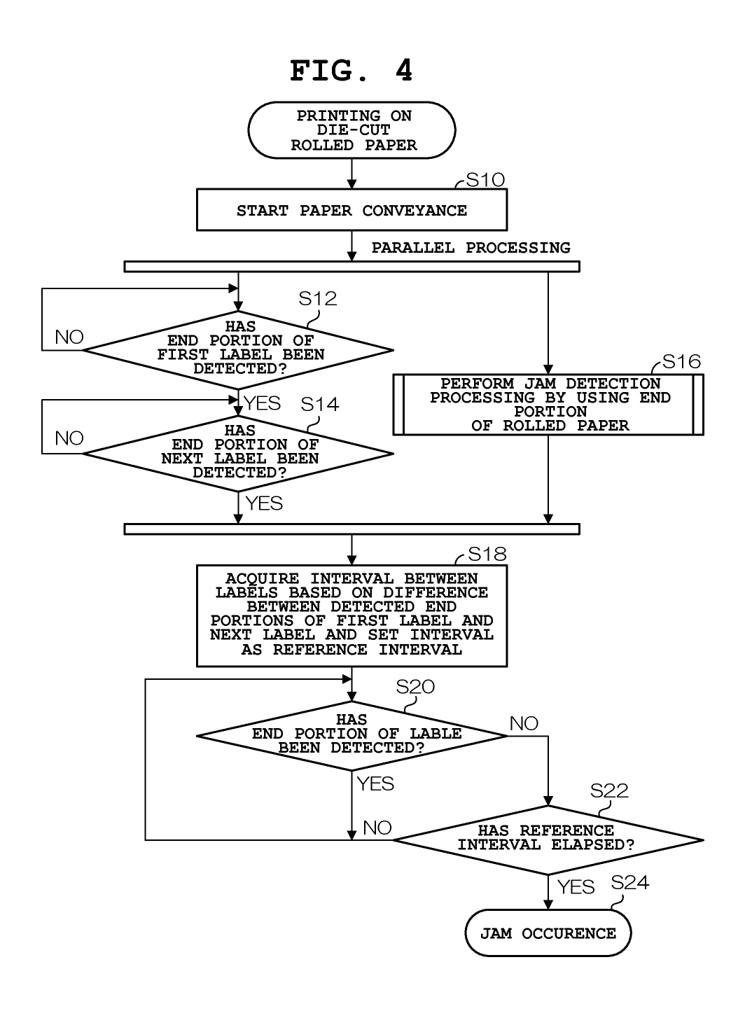

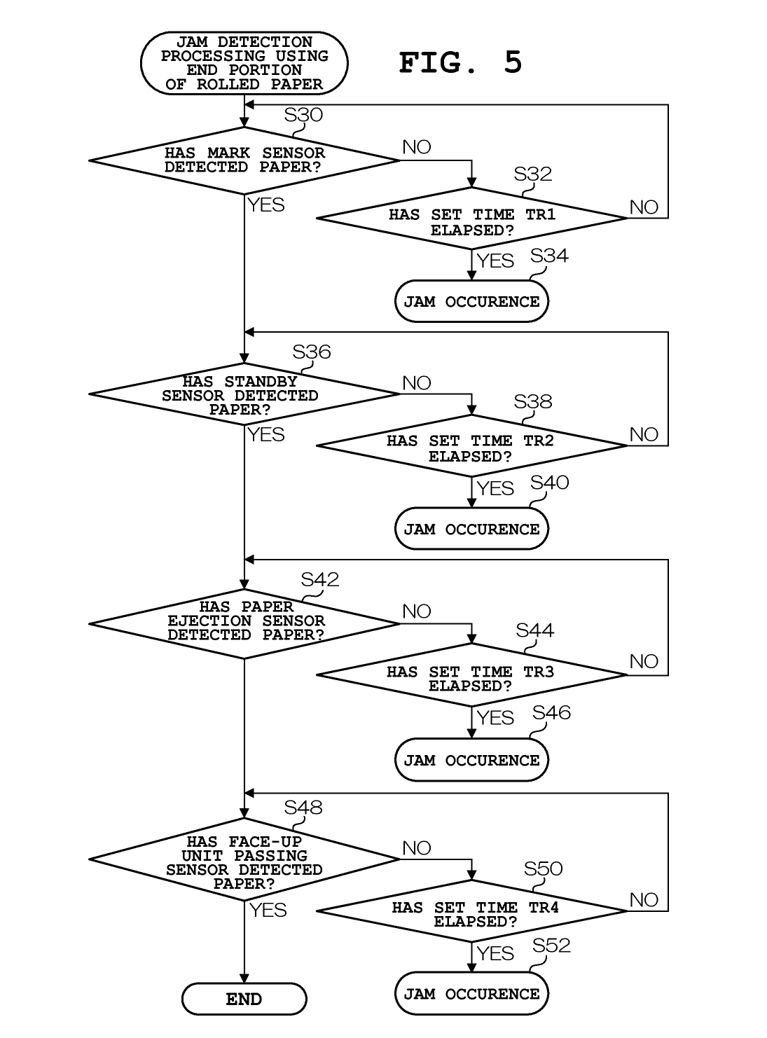

FIG. 4 and FIG. 5 are the flowcharts for describing an operation (jam detection processing) of the image forming apparatus 10 according to the present embodiment. In the image forming apparatus 10, when paper conveyance is started with the start of printing, the control section 75 sends the print target medium (long paper) 21a from the paper feed roll 21 by the unwinder driving section 73 (Step S10). Here, the end portion LE of the print target medium (long paper) 21a first passes through the mark sensor 23.

Subsequently, the control section 75 judges whether the end portion E1 of the first label 80a has been detected by the mark sensor 23 (Step S12). When judged that the end portion E1 of the first label 80a has not been detected (NO at Step S12), the control section 75 judges that the end portion E1 of the first label 80a has not reached the mark sensor 23. Accordingly, the control section 75 returns to Step S12, and repeats the judgment regarding whether or not the end portion E1 of the first label 80a has been detected.

When judged that the end portion E1 of the first label 80a has been detected (YES at Step S12), the control section 75 judges whether the end portion E2 of the next label 80b has been detected by the mark sensor 23 (Step S14). When judged that the end portion E2 of the next label 80b has not been detected (NO at Step S14), the control section 75 judges that the end portion E2 of the next label 80b has not reached the mark sensor 23. Accordingly, the control section 75 returns to Step S14, and repeats the judgment regarding whether or not the end portion E2 of the next label 80b has been detected.

In parallel with the processing at Step S12 and Step S14, the control section 75 performs jam detection processing by using the end portion LE of the print target medium (long paper) 21a (Step S16). In the jam detection processing, the control section 75 judges whether the conveyance of the print target medium (long paper) 21a is being performed normally or has been stopped (jam) in the middle, based on whether or not the print target medium (long paper) 21a has passed through the standby sensor 47, the paper ejection sensor 48, and the face-up unit passing sensor 49 within the set time TR. Details of this jam detection processing will be described later.

In the processing at Step S12 and Step S14, when the end portion E2 of the next label 80b is detected (YES of Step S14), the control section 75 calculates an interval between the labels based on a difference between a time point at which the end portion E1 of the first label 80a has been detected and a time point at which the end portion E2 of the next label 80b has been detected, and takes this interval between the labels 80a and 80b as a reference interval T (Step S18). Next, the control section 75 judges whether an end portion of another label has been detected by the mark sensor 23 (Step S20). For example, in the case where the end portion E2 of the label 80b has been detected, the control section 75 judges whether the end portion E3 of the label 80c has been detected.

When judged that an end portion of another label has not been detected (NO at Step S20), the control section 75 judges whether the above-described reference interval T has elapsed after the detection of the preceding label (Step S22). For example, in the case where the end portion E2 of the label 80b has been detected, the control section 75 judges whether the time elapsed from the detection of the end portion E2 of the label 80b is equal to or more than the reference interval T. When the time elapsed from the detection is not equal to or more than the reference interval T (NO at Step S22), the control section 75 judges that an end portion of the next label has not reached the mark sensor 23, and returns to Step S20. For example, in the case where the end portion E2 of the label 80b has been detected, the control section 75 judges that the end portion E3 of the label 80c has not been detected.

At Step S20, when judged that an end portion of another label has been detected (YES at Step S20), the control section 75 return to Step S20, and repeats Step S20 and Step S22 until an end portion of still another label is detected. Here, the control section 75 clocks the time elapsed from the detection of the end portion of the label by a timer. For example, in a case where the end portion E3 of the label 80c has been detected, the control section 75 clocks elapsed time until an end portion E4 of the next label 80d is detected by using the timer.

Then, when an end portion of still another label is detected (YES at Step S20), the control section 75 resets the timer, returns to Step S20, and repeats Step S20 and Step S22 until an end portion of yet another label is detected. Here, the control section 75 again clocks the time elapsed from the detection of the end portion of the label by the timer.

At Step S22, when elapsed time from when an end portion of a label is detected until when an end portion of the next label is detected is more than the reference interval T (YES at Step S22), the control section 75 judges that the labels are not being conveyed at the measured actual label intervals, and that a jam has occurred, and performs processing for displaying a notification regarding the error occurrence on the operation panel 70 (Step S24).

Next, the jam detection processing is described in detail with reference to FIG. 5. As described above, an end portion of brand-new long paper includes the preliminary portion 81 (refer to FIG. 3) having a certain length, which is actually constituted by only paper and has no label pasted thereon. At this preliminary portion 81, no label is detected and therefore a misjudgment is made that a jam has occurred. Accordingly, in the present embodiment, until the measurement of an interval between labels is completed, the jam detection processing is parallelly performed in which a judgment regarding the occurrence of a jam is made by detecting whether or not an end portion of the print target medium (long paper) 21a has passed through each conveyance path.

First, the control section 75 judges whether an end portion of the print target medium (long paper) 21a has been detected by the mark sensor 23 (Step S30). When judged that an end portion of the print target medium (long paper) 21a has not been detected by the mark sensor 23 (NO at Step S30), the control section 75 judges whether a set time TR1 has elapsed from the start of the conveyance (Step S32). Then, when judged that the set time TR1 has not elapsed from the start of the conveyance (NO at Step S32), the control section 75 judges that a jam has not occurred, and therefore returns to Step S30 to repeat the detection of an end portion of the print target medium (long paper) 21a by the mark sensor 23.

Conversely, when judged that an end portion of the print media (long paper) 21a has not been detected by the mark sensor 23 and the set time TR1 has elapsed from the start of the conveyance (YES at Step S32), the control section 75 judges that the conveyance of the print target medium (long paper) 21a is being disrupted by the occurrence of a jam, and performs processing of displaying a notification regarding the occurrence of the error on the operation panel 70 (Step S34).

At Step S30, when judged that an end portion of the print target medium (long paper) 21a has been detected by the mark sensor 23 (YES at Step S30), the control section 75 judges whether the end portion of the print target medium (long paper) 21a has been detected by the standby sensor 47 (Step S36). When judged that the end portion of the print target medium (long paper) 21a has not been detected by the standby sensor 47 (NO at Step S36), the control section 75 judges whether a set time TR2 has elapsed from the start of the conveyance (Step S38). Then, when judged that the set time TR2 has not elapsed from the start of the conveyance (NO at Step S38), the control section 75 judges that a jam has not occurred, and therefore returns to Step S36 to repeat the detection of the end portion of the print target medium (long paper) 21a by the standby sensor 47.

Conversely, when judged that the end portion of the print media (long paper) 21a has not been detected by the standby sensor 47 and the set time TR2 has elapsed from the start of the conveyance (YES at Step S38), the control section 75 judges that the conveyance of the print target medium (long paper) 21a is being disrupted by the occurrence of a jam, and performs processing of displaying a notification regarding the occurrence of the error on the operation panel 70 (Step S40).

At Step S36, when judged that the end portion of the print target medium (long paper) 21a has been detected by the mark sensor 23 and the standby sensor 47 (YES at Step S30 and Step S36), the control section 75 judges whether the end portion of the print target medium (long paper) 21a has been detected by the paper ejection sensor 48 (Step S42). When judged that the end portion of the print target medium (long paper) 21a has not been detected by the paper ejection sensor 48 (NO at Step S42), the control section 75 judges whether a set time TR3 has elapsed from the start of the conveyance (Step S44). Then, when judged that the set time TR3 has not elapsed from the start of the conveyance (NO at Step S44), the control section 75 judges that a jam has not occurred, and therefore returns to Step S42 to repeat the detection of the end portion of the print target medium (long paper) 21a by the paper ejection sensor 48.

Conversely, when judged that the end portion of the print media (long paper) 21a has not been detected by the paper ejection sensor 48 and the set time TR3 has elapsed from the start of the conveyance (YES at Step S44), the control section 75 judges that the conveyance of the print target medium (long paper) 21a is being disrupted by the occurrence of a jam, and performs processing of displaying a notification regarding the occurrence of the error on the operation panel 70 (Step S46).

At Step S42, when judged that the end portion of the print target medium (long paper) 21a has been detected by the mark sensor 23, the standby sensor 47, and the paper ejection sensor 48 (YES at Step S30, Step S36, and Step S42), the control section 75 judges whether the end portion of the print target medium (long paper) 21a has been detected by the face-up unit passing sensor 49 (Step S48).

When judged that the end portion of the print target medium (long paper) 21a has not been detected by the face-up unit passing sensor 49 (NO at Step S48), the control section 75 judges whether a set time TR4 has elapsed from the start of the conveyance (Step S50). Then, when judged that the set time TR4 has not elapsed from the start of the conveyance (NO at Step S50), the control section 75 judges that a jam has not occurred, and therefore returns to Step S48 to repeat the detection of the end portion of the print target medium (long paper) 21a by the face-up unit passing sensor 49.

Conversely, when judged that the end portion of the print media (long paper) 21a has not been detected by the face-up unit passing sensor 49 and the set time TR4 has elapsed from the start of the conveyance (YES at Step S50), the control section 75 judges that the conveyance of the print target medium (long paper) 21a is being disrupted by the occurrence of a jam, and performs processing of displaying a notification regarding the occurrence of the error on the operation panel 70 (Step S52).

At Step S48, when judged that the end portion of the print target medium (long paper) 21a has been detected by the mark sensor 23, the standby sensor 47, the paper ejection sensor 48, and the face-up unit passing sensor 49 (YES at Step S30, Step S36, Step S42, and Step S48), the control section 75 judges that no jam has occurred and ends the processing.

As described above, in the present embodiment, until the measurement of an interval between labels is completed, a jam is judged to have occurred when an end portion of the print target medium (long paper) 21a does not pass through the mark sensor 23, the standby sensor 47, the paper ejection sensor 48, and the face-up unit passing sensor 49 arranged along the conveyance path of the print target medium (long paper) 21a within the set time TR1, the set time TR2, the set time TR3, and the set time TR4, respectively. As a result of this configuration, erroneous detection of a jam of the preliminary portion 81 that does not have labels pasted thereon can be prevented.

Also, in the present embodiment, the end portions E1 and E2 of the first label 80a and the next label 80b pasted on the print target medium (long paper) 21a are detected, the actual label interval is measured thereby, and whether or not the conveyance of the print media (long paper) 21a has been stopped is judged based on the reference interval and an interval between labels detected after the measurement. As result of this configuration, the user is not required to know in advance each interval between labels pasted in advance on the print target medium (long paper) 21a or the size of the labels, whereby the complexity of the operation can be reduced, and a jam occurrence can be precisely detected.

Moreover, in the present embodiment, until the measurement of an interval between labels is completed, a jam is judged to have occurred when an end portion of the print target medium (long paper) 21a does not pass through the mark sensor 23, the standby sensor 47, the paper ejection sensor 48, and the face-up unit passing sensor 49 arranged along the conveyance path of the print target medium (long paper) 21a within the set time TR. As a result of this configuration, erroneous detection of a jam of the preliminary portion 81 that does not have labels pasted thereon can be prevented.

In the above-described embodiment, an actual interval between labels is measured. However, the present invention is not limited thereto. For example, marks printed in advance may be detected and an interval between marks may be taken as the standard interval T. In this configuration, the user is not required to know in advance each interval between marks printed in advance on the print target medium (long paper) 21a, so that the complexity of the operation can be reduced.

While the present invention has been described with reference to the preferred embodiments, it is intended that the invention be not limited by any of the details of the description therein but includes all the embodiments which fall within the scope of the appended claims.

What is claimed is:

1. An image forming apparatus comprising:
a first detection section which detects marks printed in advance on a print target medium that is being conveyed or labels pasted on the print target medium;
a measurement section which measures an interval between marks or an interval between labels detected by the first detection section after conveyance of the print target medium is started, and sets the interval as a reference interval; and
a judgment section which judges whether the conveyance of the print target medium has been stopped, based on an interval between marks or an interval between labels detected by the first detection section after measurement by the measurement section and the reference interval.

2. The image forming apparatus according to claim 1, further comprising:
a second detection section,
wherein the judgment section judges whether the conveyance of the print target medium has been stopped based on whether the print target medium being conveyed on a conveyance path has been detected by the second detection section, during a period of time where the marks or the labels are not detected by the first detection after the conveyance of the print target medium is started.

3. The image forming apparatus according to claim 1, further comprising:
a second detection section,
wherein the judgment section judges whether the conveyance of the print target medium has been stopped based on whether the print target medium being conveyed on a conveyance path has been detected by the second detection section, until a first mark or a first label is detected by the first detection after the conveyance of the print target medium is started.

4. The image forming apparatus according to claim 2, wherein second detection sections are arranged in a plurality of areas on the conveyance path, and
wherein the judgment section judges that the conveyance of the print target medium has been stopped, when one of the second detection sections arranged in the plurality of areas does not detect the print target medium within a predetermined set time after the conveyance of the print target medium is started.

5. The image forming apparatus according to claim 3, wherein second detection sections are arranged in a plurality of areas on the conveyance path, and
wherein the judgment section judges that the conveyance of the print target medium has been stopped, when one of the second detection sections arranged in the plurality of areas does not detect the print target medium within a predetermined set time after the conveyance of the print target medium is started.

6. The image forming apparatus according to claim 1, wherein the measurement section measures an interval between a first mark and a second mark detected by the first detection section or an interval between a first label and a second label detected by the first detection section after the conveyance of the print target medium is started.

7. The image forming apparatus according to claim 1, wherein the judgment section judges that the conveyance of the print target medium has been stopped, when the interval between the marks or the interval between the labels detected by the first detection section after the measurement by the measurement section is longer than the reference interval.

8. The image forming apparatus according to claim 1, wherein the first detection section is an optical sensor, and detects the marks or the labels by setting in advance a threshold value conforming to the print target medium.

9. The image forming apparatus according to claim 8, wherein the marks are printed with a fluorescent ink, and
wherein the optical sensor includes an ultraviolet irradiation section.

10. The image forming apparatus according to claim 1, wherein the marks are printed with a magnetic ink, and
wherein the first detection section is a magnetic sensor.

11. The image forming apparatus according to claim 10, wherein the marks have magnetic data recorded thereon,
wherein the magnetic sensor reads out the magnetic data and classifies the marks into plural types, and
wherein printing on the labels are performed at timing according to the classification.

12. The image forming apparatus according to claim 1, wherein the marks are printed with a conductive ink, and
wherein the first detection section is a resistance measurement sensor.

13. The image forming apparatus according to claim 1, wherein the marks are printed with an insulating ink, and
wherein the first detection section is an electrostatic capacitance sensor.

14. The image forming apparatus according to claim 1, wherein the first detection section has a plurality of detection methods, sets in advance positions of the labels with respect to the marks in accordance with the detection methods, and performs printing on the labels at timing of detection by the first detection section by one of the plurality of detection methods.

15. The image forming apparatus according to claim 14, wherein one of the plurality of detection methods is a detection method using light, magnetism, conductivity, or permittivity.

16. A jam detection method comprising:
a first detection step of detecting marks printed in advance on a print target medium or labels pasted on the print target medium;
a measurement step of measuring an interval between marks or an interval between labels detected after conveyance of the print target medium is started, and setting the interval as a reference interval; and
a judgment step of judging whether the conveyance of the print target medium has been stopped, based on an interval between marks or an interval between labels detected after measurement of the interval between the marks or the interval between the labels.

17. The jam detection method according to claim 16, further comprising:
a second detection step of detecting the print target medium,
wherein the judgment step judges whether the conveyance of the print target medium has been stopped based on whether the print target medium has been detected in the second detection step, during a period of time where the labels are not detected in the first detection step.

18. The jam detection method according to claim 16, further comprising:
a second detection step of detecting the print target medium,
wherein the judgment step judges whether the conveyance of the print target medium has been stopped based on whether the print target medium has been detected in the second detection step, until a first label is detected in the first detection step.

19. The jam detection method according to claim 17, wherein the second detection step detects the print target medium by sensors in a plurality of areas, and
wherein the judgment step judges that the conveyance of the print target medium has been stopped, when one of the sensors in the plurality of areas does not detect the print target medium within a predetermined set time conforming to a sensor after the conveyance of the print target medium is started.

20. The jam detection method according to claim 18, wherein the second detection step detects the print target medium by sensors in a plurality of areas, and
wherein the judgment step judges that the conveyance of the print target medium has been stopped, when one of the sensors in the plurality of areas does not detect the print target medium within a predetermined set time conforming to a sensor after the conveyance of the print target medium is started.
